(19) United States
(12) Patent Application Publication
(10) Pub. No.: US 2026/0326904 A1
(43) Pub. Date: Oct. 22, 2026

(54) AIRCRAFT PROPULSION SYSTEM AND AN AIRCRAFT

(71) Applicant: Airbus Operations SAS, TOULOUSE (FR)

(72) Inventors: Pierre-Antoine COMBES, TOULOUSE (FR); Nicolas JOLIVET, TOULOUSE (FR); Michael BERJOT, TOULOUSE (FR)

(21) Appl. No.: 19/649,659

(22) Filed: Apr. 16, 2026

Related U.S. Application Data
(60) Provisional application No. 63/790,512, filed on Apr. 17, 2025.

(51) Int. Cl. B64D 27/40

(52) U.S. Cl. CPC B64D 27/402

(57) ABSTRACT

A mounting assembly for securing an aircraft engine to a wing via a pylon. The mounting assembly including a front engine mount with two rods extending between front engine lugs and a pylon yoke and two shackles extending between pylon lugs and engine lugs. Each shackle is connected at two points to a middle engine lugs. The components may be doubled.

### CROSS-REFERENCE TO RELATED APPLICATIONS

This application which claims the benefit of U.S. Pat. Application Ser. No. 63/790,512, filed on Apr. 17, 2025, the entire disclosures of which are incorporated herein by way of reference.

### FIELD OF THE INVENTION

The present invention relates to an aircraft propulsion system and an aircraft with a propulsion system, and in particular wherein the propulsion system includes a turbojet engine and attachment means for securing the turbojet engine to the aircraft.

### BACKGROUND OF THE INVENTION

An aircraft conventionally has a plurality of propulsion systems. Each propulsion system is generally secured underneath a wing of the aircraft and includes a powerplant, for example, a turbojet engine, secured under the wing and attachment means for securing the turbojet engine under the wing.

Although current propulsion systems are satisfactory and meet the necessary requirements, the assembly and disassembly of the attachment means or mounting assemblies which connect a pylon and an engine are generally lengthy and complex. There is an ongoing need and desire to provide to mounting assemblies that reduces installation time and complexity while meeting the necessary requirements.

### SUMMARY OF THE INVENTION

New engine mounting assemblies have been invented. The new engine mounting assemblies do not generate major aero hard-points for external aerodynamic lines. Additionally, in the new engine mounts, failsafe scenarios are fully considered. Further, the engine mounts architecture shall be defined so that the loads at each interface are reasonable and well distributed between each interface. In addition to meeting the foregoing requirements, in the new engine mounts, the engine to pylon interfaces provide an easy/simple accessibility for engine installation/removability.

According to one or more aspects, the present invention may be characterized as providing a mounting assembly for securing an aircraft engine to a wing via a pylon, the mounting assembly comprising: a front engine mount disposed above a fan casing of the aircraft engine, the front engine mount including: two front rods extending between respective front engine lugs and a pylon yoke, and two shackles extending between respective pylon lugs and respective middle engine lugs, wherein each of the two shackles is connected to the respective middle engine lugs by two connection points, and, wherein the front engine mount is configured to provide a fail-safe load path such that, upon failure of one of the two front rods, loads are transferred through at least one of the two shackles to maintain attachment of the aircraft engine to the pylon.

The two shackles may extend in a generally vertical direction and may be arranged to transmit loads primarily along a vertical axis.

The middle engine lugs may be disposed between the front engine lugs and a rear engine mount.

The two front rods may extend in a non-parallel relationship relative to one another.

At least one of the two connection points of each shackle may be a dual load path connection point. At least one of the connection points of each shackle may be a single-path connection point.

The two front rods may not be doubled, and a fail-safe functionality may be achieved by the two shackles and the connection points.

The two shackles may be doubled.

Each shackle may be coupled to the pylon through a doubled axis.

The two front rods and the two shackles may cooperate to transmit loads along longitudinal, transverse, and vertical axes of the aircraft engine while limiting introduction of bending moments into the front engine mount.

The mounting assembly may also include: a rear engine mount including rear rods extending between the aircraft engine and the pylon. The rear rods may be doubled.

According to one or more aspects, the present invention may also be characterized as providing an aircraft comprising: a wing; an engine having a fan casing; a pylon secured to the wing; and a mounting assembly as described herein securing the engine to the pylon.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

The characteristics of the invention will emerge more clearly from a reading of the following description of at least one example of embodiment, said description being produced with reference to the accompanying drawings, among which:

FIG. 1 is a side view of an aircraft comprising an assembly according to the invention;

FIG. 2 is a side view of an assembly according to the invention;

FIG. 3A is a schematic representation of conventional structure with single load paths;

FIG. 3B is a schematic representation of structure with dual load paths;

FIG. 4 is a side view of an assembly according to the invention showing loads taken up by the components of the assembly;

FIG. 5 is a close-up view of the front engine mount of an assembly according to the invention;

FIG. 6 is close-up side view of a portion of the assembly according to the invention;

FIG. 7 is close-up side, perspective view of a portion of the assembly according to the invention;

FIG. 8A is a top view of an assembly according to the invention showing the loads being transferred in case of a failure of one of the front rods; and,

FIG. 8B is a side view of the assembly of FIG. 8A showing the loads being transferred with the failure of one of the front rods.

In general, the same reference numbers will be used throughout the drawing(s) and accompanying written description to refer to the same or like parts.

### DETAILED DESCRIPTION

As mentioned above, new engine mounting assemblies have been invented.

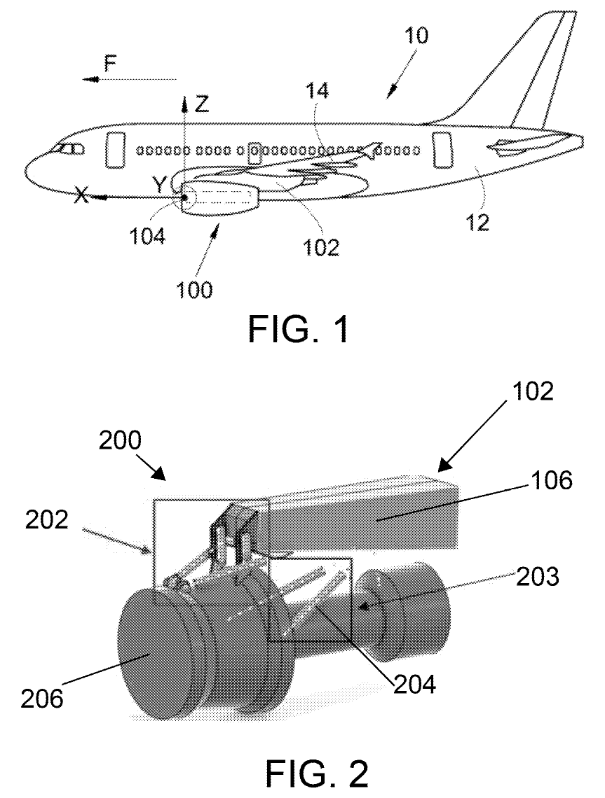

FIG. 1 shows an aircraft 10 which has a propulsion system 100. The aircraft 10 has, on both sides of a fuselage 12, a wing 14 to which an engine pylon 102 is fixed. The propulsion system 100 generally includes the engine pylon 102 and an engine 104.

In the following description, and by convention, X is called the longitudinal axis of the engine oriented positively in the direction of advance of the aircraft 10, it is called Y, the transverse axis of the engine which is horizontal when the aircraft is on the ground, and Z, the vertical axis or vertical height when the aircraft is on the ground, these three axes X, Y and Z being mutually orthogonal. The fore and aft positions are taken in relation to the forward and aft of the aircraft 10. The direction of advancement of aircraft 10 is given by the arrow F which shows the direction in which aircraft 10 advances when engines 104 are running. The engine 104 has a vertical median plane P (XZ).

In the frame of the aircraft engine 104 with high loads to be transferred from the engine 104 to the wing 14, there are specific requirements for engine mounts systems between the pylon 102 and the engine 104.

The new engine mounting assemblies 200 are shown FIGS. 2 and 4 to 8B with front engine mounts 202. The new engine mounting assemblies 200 also include rear engine mounts 203 with rear rods 204 connecting the core of the engine 104 to the pylon 102.

The front engine mounts 202 are disposed above the fan casing 206 of the engine 104, and utilize using various mechanical attachment structures (rods, mechanical parts, etc.). In general, the arrangement of mechanical parts between the pylon 102 and engine 104 can be: in a deterministic manner (6 Degrees of Freedom); in a deterministic manner (6 Degrees of Freedom) with a waiting failsafe interface; or in a statically undetermined manner (more than 6 Degrees of Freedom) (hyperstatism). In the presently depicted embodiment, two waiting fail safe (WFS)connection points are provided on vertical shackles. These WFS connection points compensate for the failure loss of one of the front rods.

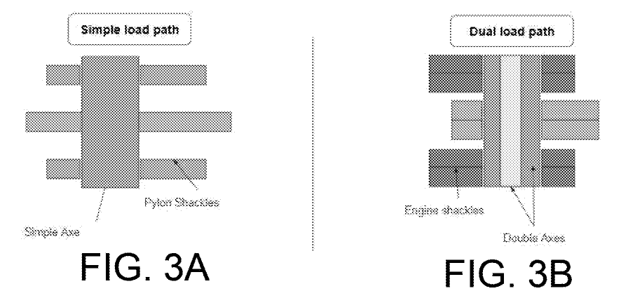

As may be used herein, a “dual load path” refers to a structure that is fail safe when it is damage tolerant: in case of failure or rupture (total or partial) of one of its components, it can continue to ensure its functions, at least up to the next inspection control. To continue performing these functions, the constituent elements are doubled. The two-part main support allows the transmission of loads along the X, Y and Z axes via two different paths. This design does not introduce any moment into the front support or into the forward mount. A conventional structure is shown in FIG. 3A and an example dual load path structure is depicted in FIG. 3B.

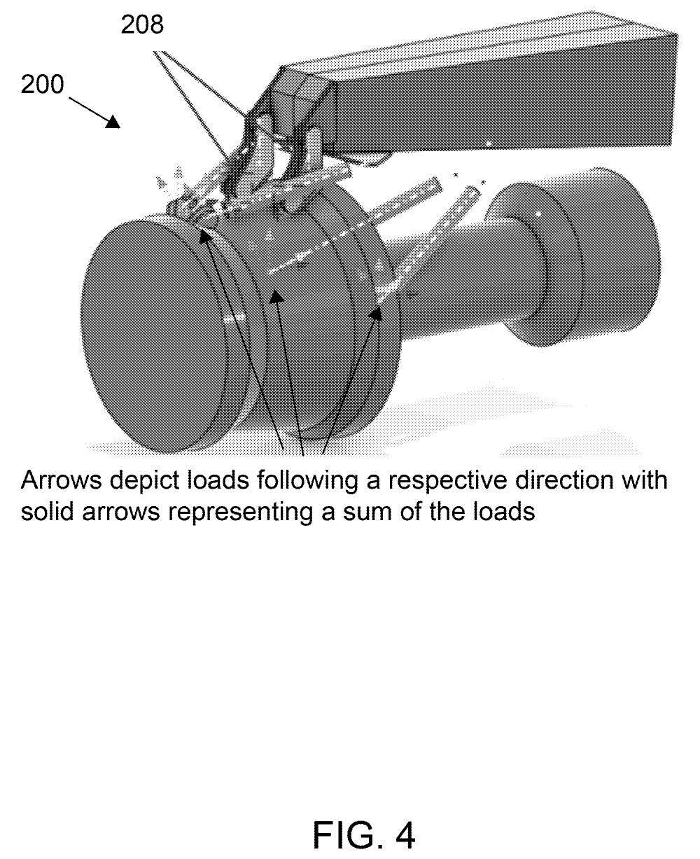

As can be seen in FIG. 4, the present embodiment of the invention includes two sets of rods 204, 208 to ensure a widespread attachment to the engine 104, thus making the best of the available wheelbases between engine strong frames. Working in a pair, these rods 204, 208 with a XYZ-projection help transferring all loads (TX, TY and TZ) and balancing moments (especially MY and MZ). As shown in FIG. 4, the color of the arrows reflects the direction in which the loads are flowing in the depicted embodiment.

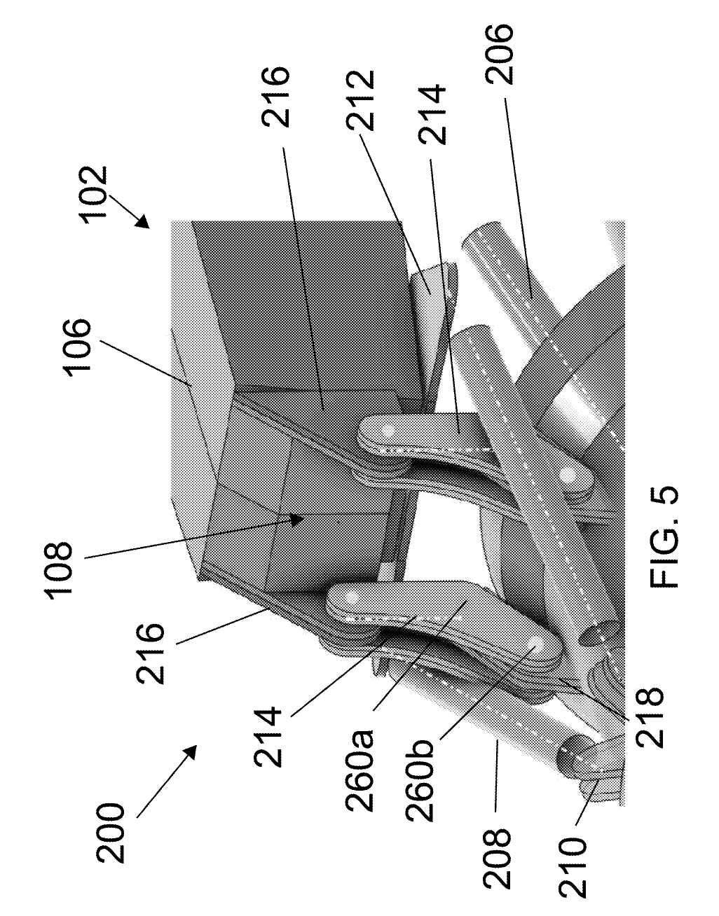

Turning to FIGS. 5 to 7, the front rods 208 extend between front engine lugs 210 and a yoke 212 on the pylon 102. Ball bearings (not shown) may be present at each end of the rods 204, 208.

The front engine mounts 202 also includes front shackles 214 with interfaces distributed within the volume of the front rib 106 (called N1) of the pylon box 108. The front shackles 214 extend between pylon lugs 216 and mid engine lugs 218. The compact design optimizes the aerodynamic integration of the area, which is very sensitive because it is blown by the fan jet and close to the propeller of the engine 104.

As shown in FIG. 5, each shackle 214 is connected at two connection points 260a, 260b to a middle engine lug 218. One of the connection points 260a, 260b may utilize a simple (single piece) connector. The other, or both, of the two connection points 260a, 260b utilizes a double connector or dual load path connector.

These connection points 260a, 260b compensate the loss of one rod 204, 208. This makes it possible to preserve a resilient fail-safe assembly without requiring a doubling of the rods 204, 208.

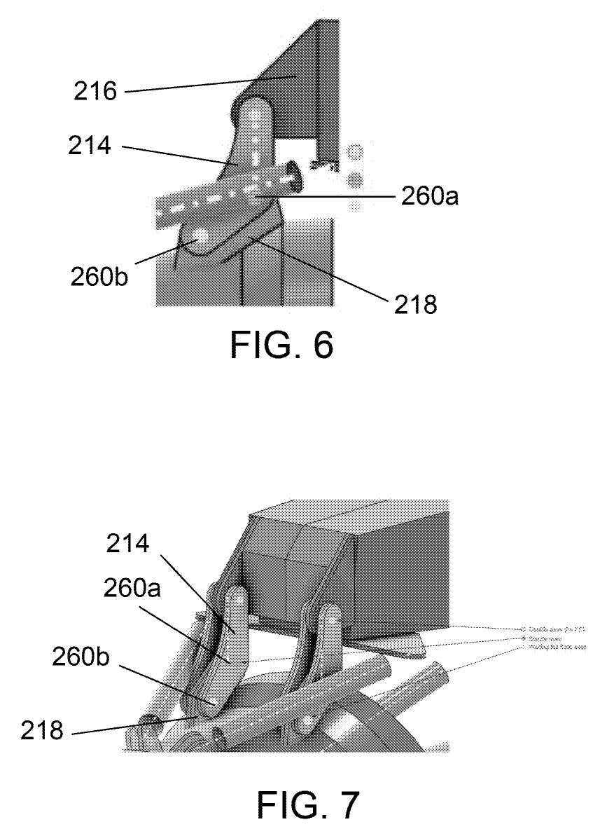

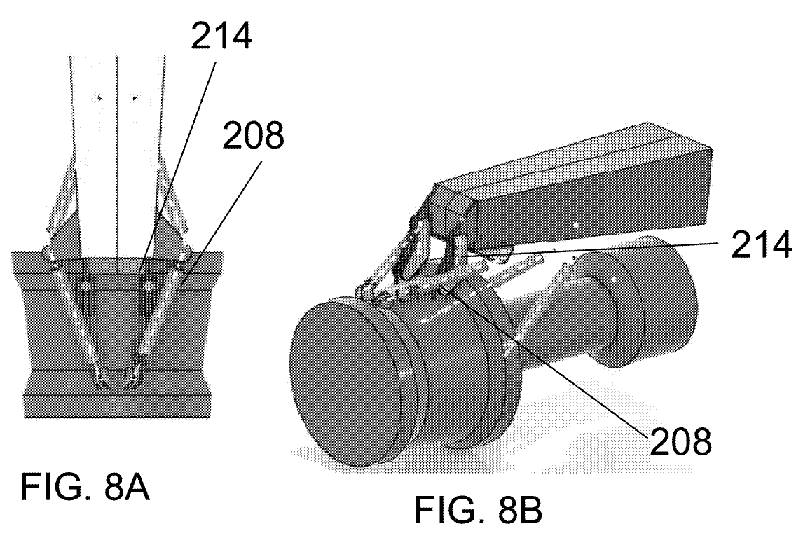

As shown in FIGS. 6 and 7, if a first connection point 260a is a simple one, the WFS connection point axis 260b is activated in case of the failure of the first connection point 260a or front rod 208 failure. If the first connection point 260a is doubled, the WFS connection point axis 260b is only activated in case of one front rod 208 failure. See, FIGS. 8A and 8B.

While the use connection points 260a, 260b as a WFS connection point does not require a doubling of the rods 208, the vertical shackles 214 are doubled to preserve the integrity of the mounting assembly in case of a failed shackle 214 (doubled shackle 214, lugs, and pins). The axis connected to the pylon 102 is mandatorily doubled to prevent its loss, so is the shackle 214.

According to the present invention, the following components form the fail-safe system:
front rods 204: not doubled;
rear rods with the following doubled elements: rear engine lug, engine rear rod axis, rear rod 208, pylon axis; and,
Shackles with the following doubled elements: engine yoke 212, engine shackle axis, shackle 214, pylon shackle axis, pylon lugs 216, front rib 106 (inboard and outboard).

The compact aspect of the depicted embodiment mitigates potential impacts on external aerodynamic lines and associated drag penalties. The several rods ensure the transfer of loads while being contained within the nacelle lines. The depicted embodiment enables an efficient integration of the power plant system from both an A/C and engine standpoint.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A mounting assembly for securing an aircraft engine to a wing via a pylon, the mounting assembly comprising:
a front engine mount disposed above a fan casing of the aircraft engine,
the front engine mount including:
two front rods extending between respective front engine lugs and a pylon yoke, and
two shackles extending between respective pylon lugs and respective middle engine lugs,
wherein each of the two shackles is connected to the respective middle engine lugs by two connection points, and,
wherein the front engine mount is configured to provide a fail-safe load path such that, upon failure of one of the two front rods, loads are transferred through at least one of the two shackles to maintain attachment of the aircraft engine to the pylon.

2. The mounting assembly of claim 1, wherein the two shackles extend in a generally vertical direction and are arranged to transmit loads primarily along a vertical axis.

3. The mounting assembly of claim 1, wherein the middle engine lugs are disposed between the front engine lugs and a rear engine mount.

4. The mounting assembly of claim 1, wherein the two front rods extend in a non-parallel relationship relative to one another.

5. The mounting assembly of claim 1, wherein at least one of the two connection points of each shackle comprises a dual load path connection point.

6. The mounting assembly of claim 5, wherein at least one of the two connection points of each shackle comprises a single-path connection point.

7. The mounting assembly of claim 1, wherein the two front rods are not doubled, and
wherein a fail-safe functionality is achieved by the two shackles and the two connection points of each shackle.

8. The mounting assembly of claim 1, wherein the two shackles are doubled.

9. The mounting assembly of claim 1, wherein each shackle is coupled to the pylon through a doubled axis.

10. The mounting assembly of claim 1, wherein the two front rods and the two shackles cooperate to transmit loads along longitudinal, transverse, and vertical axes of the aircraft engine while limiting introduction of bending moments into the front engine mount.

11. The mounting assembly of claim 1, further comprising:
a rear engine mount including rear rods extending between the aircraft engine and the pylon.

12. The mounting assembly of claim 11, wherein the rear rods are doubled.

13. An aircraft comprising:
a wing;
an engine having a fan casing;
a pylon secured to the wing; and
the mounting assembly of claim 1 securing the engine to the pylon.
